(19) United States
(12) Patent Application Publication
(10) Pub. No.: US 2018/0001529 A1
(43) Pub. Date: Jan. 4, 2018

(54) INJECTION MOLDING WITH TARGETED HEATING OF MOLD CAVITIES IN A NON-MOLDING POSITION

(71) Applicant: IMFLUX INC., Hamilton, OH (US)

(72) Inventors: Gene Michael Altonen, Hamilton, OH (US); Chow-Chi Huang, West Chester, OH (US); Jes Tougaard Gram, Georgetown (KY)

(21) Appl. No.: 15/616,353

(22) Filed: Jun. 7, 2017

Related U.S. Application Data
(60) Provisional application No. 62/356,651, filed on Jun. 30, 2016.

(51) Int. Cl. B29C 45/73; B29C 45/40; B29C 45/04; B29K 101/12; B29K 105/00

(52) U.S. Cl. CPC B29C 45/73; B29C 45/40; B29C 45/0441; B29K 2105/0067; B29K 2101/12

(57) ABSTRACT

Injection molding utilizing targeted heating of mold cavities when in a non-molding position, thereby facilitating enhancement of the appearance and strength of injection molding parts in a manner that does not significantly increase cycle times or energy consumption.

### CROSS-REFERENCE TO RELATED APPLICATIONS

This application is the non-provisional, which claims the benefit of the filing date under 35 USC §119(e), of U.S. Provisional Application No. 62/356,651, filed Jun. 30, 2016, which is hereby incorporated by reference in its entirety.

### TECHNICAL FIELD

This disclosure relates generally to apparatuses and methods for injection molding and, more particularly, to apparatuses and methods for performing injection molding while utilizing targeted heating of mold cavities to enhance the quality of injection molded products and product components.

### BACKGROUND

Injection molding is a technology commonly used for high-volume manufacturing of parts made of thermoplastic material. During a repetitive injection molding process, a thermoplastic resin, most often in the form of small beads or pellets, is introduced to an injection molding machine that melts the resin beads under heat and pressure. The now molten resin is forcefully injected into a mold cavity having a particular cavity shape. The injected plastic is held under pressure in the mold cavity, cooled, and then removed as a solidified part having a shape that essentially duplicates the cavity shape of the mold. The mold itself may have a single cavity or multiple cavities.

An injection molding cycle, as used herein, or simply “cycle”, can include the steps of (1) melting a shot of polymeric material; (2) clamping together two (or more) portions of a mold, such as a mold core and a mold cavity plate, that together form the mold walls that define one or more mold cavities (typically while the mold walls are in a cool condition relative to the temperature to which the molten thermoplastic material is heated prior to injection into the mold cavity); (3) forcing the shot of molten polymeric material into the mold cavity; (4) waiting some period of time until the molded polymeric material cools to a temperature sufficient to eject the part, i.e. a temperature below its melt temperature, so that at least outside surfaces of the molded part are sufficiently solid so that the part will maintain its molded shape once ejected; (5) opening the portions of the mold that define the one or more mold cavities; (6) ejecting the molded part(s) from the one or more mold cavities; and (7) closing the two (or more) mold sections (for a subsequent cycle).

In some cycles, the surfaces of the mold that define the mold cavity can be heated after step (2) or during step (3), i.e., after the portions of the mold are clamped together or while the shot of molten thermoplastic material is forced into the mold cavity, so as to enhance the appearance and strength of the injection molded part. Heating the surfaces of the mold in this manner can enhance the appearance and strength of the injection molded part by, for example, enhancing the surface finish of the molded part, reducing residual stress in the molded part, and providing a stronger weld line on the surface of the molded part. Examples of heating techniques that may be used to heat surfaces of the mold that define the mold cavity are: Resistive heating (or joule heating), conduction, convection, use of heated fluids (e.g., superheated steam or oil in a manifold or jacket, also heat exchangers), radiative heating (such as through the use of infrared radiation from filaments or other emitters), RF heating (or dielectric heating), electromagnetic inductive heating (also referred to herein as induction heating), use of thermoelectric effect (also called the Peltier-Seebeck effect), vibratory heating, acoustic heating, and use of heat pumps, heat pipes, cartridge heaters, or electrical resistance wires, whether or not their use is considered within the scope of any of the above-listed types of heating.

A known drawback of heating the surfaces of the mold immediately before or while the shot of molten thermoplastic material is forced into the mold cavity is that it often results in an increase in cycle time, for instance because of the additional time it takes for additional heat to dissipate or be drawn out of the mold walls. It also increases the energy consumed by the injection molding system. Before the surfaces of the mold that define the mold cavity can be opened and the molded part ejected, the part must be cooled to a temperature below its melt temperature so that the part solidifies, and active cooling techniques require additional energy. Additionally, as a result of the heating, part solidification takes longer to occur, thereby delaying the ejecting step, and increasing cycle time.

### SUMMARY OF THE INVENTION

The present disclosure describes injection molding while utilizing targeted heating of mold cavities when in a non-molding position, thereby facilitating enhancement of the appearance and strength of injection molding parts in a manner that does not significantly increase cycle times or energy consumption.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 illustrates a schematic view of an injection molding apparatus constructed according to the disclosure;

FIG. 2A is a cross-sectional view of a mold implemented in the pressure injection molding apparatus of FIG. 1, illustrating the mold in a closed position and a movable portion of the mold in a first position;

FIG. 2B is similar to FIG. 2A, but illustrates the mold in an open position;

FIG. 2C is similar to FIG. 2B, but illustrates the movable portion of the mold in a second position;

FIG. 2D is similar to FIG. 2C, but illustrates the mold in the closed position;

FIG. 3 illustrates a schematic view of another low constant pressure injection molding apparatus constructed according to the disclosure;

FIG. 4A is a cross-sectional view of a mold implemented in the pressure injection molding apparatus of FIG. 3, illustrating the mold in a closed position and a movable portion of the mold in a first position;

FIG. 4B is similar to FIG. 4A, but illustrates the mold in an open position;

FIG. 4C is similar to FIG. 4B, but illustrates the movable portion of the mold in a second position;

FIG. 4D is similar to FIG. 4C, but illustrates the mold in the closed position; and.

FIG. 5 is a cross-sectional view of another mold constructed according to the disclosure, with molding positions arranged on one face of the mold and non-molding positions arranged on an opposite face of the mold; and

FIG. 6 is a cross-sectional view of another mold constructed according to the disclosure, with molding positions and non-molding positions that alternate on each face of the mold.

### DETAILED DESCRIPTION OF THE INVENTION

Embodiments of the present invention generally relate to systems, machines, products, and methods of producing products by injection molding and more specifically to systems, products, and methods of producing products by injection molding utilizing targeted heating of mold cavities in a non-molding position.

The term “melt holder”, as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit, and can be controlled to advance a diaphragm to force molten plastic through the machine nozzle. The molten material then flows through the runner system in to the mold cavity. The melt holder may be cylindrical in cross section, or have alternative cross sections that will permit a diaphragm to force polymer under pressures that can range from as low as 100 psi to pressures 40,000 psi or higher through the machine nozzle. The diaphragm may optionally be integrally connected to a reciprocating screw with flights designed to plasticize polymer material prior to injection.

The term “peak flow rate” generally refers to the maximum volumetric flow rate, as measured at the machine nozzle.

The term “peak injection rate” generally refers to the maximum linear speed the injection ram travels in the process of forcing polymer in to the feed system. The ram can be a reciprocating screw such as in the case of a single stage injection system, or a hydraulic ram such as in the case of a two stage injection system.

The term “ram rate” generally refers to the linear speed the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder, and in the material feed system when a hot runner system is used, which keeps the polymer in a molten state. The melt temperature varies by material, however, a desired melt temperature is generally understood to fall within the ranges recommended by the material manufacturer.

The term “gate size” generally refers to the cross sectional area of a gate, which is formed by the intersection of the runner and the mold cavity. For hot runner systems, the gate can be of an open design where there is no positive shut off of the flow of material at the gate, or a closed design where a valve pin is used to mechanically shut off the flow of material through the gate in to the mold cavity (commonly referred to as a valve gate). The gate size refers to the cross sectional area, for example a 1 mm gate diameter refers to a cross sectional area of the gate that is equivalent to the cross sectional area of a gate having a 1 mm diameter at the point the gate meets the mold cavity. The cross section of the gate may be of any desired shape.

The term “effective gate area” generally refers to a cross sectional area of a gate corresponding to an intersection of the mold cavity and a material flow channel of a feed system (e.g., a runner) feeding thermoplastic to the mold cavity. The gate could be heated or not heated. The gate could be round, or any cross sectional shape, suited to achieve the desired thermoplastic flow into the mold cavity.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratio such as 50:1.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The Shot Size volume is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “electric motor” or “electric press,” when used herein includes both electric servo motors and electric linear motors.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being force ably closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “guided ejection mechanism” is defined as a dynamic part that actuates to physically eject a molded part from the mold cavity.

The term “coating” is defined as a layer of material less than 0.13 mm (0.005 in) in thickness, that is disposed on a surface of a mold part defining the mold cavity, that has a primary function other than defining a shape of the mold cavity (e.g., a function of protecting the material defining the mold cavity, or a function of reducing friction between a molded part and a mold cavity wall to enhance removal of the molded part from the mold cavity).

The term “average thermal conductivity” is defined as the thermal conductivity of any materials that make up the mold cavity or the mold side or mold part. Materials that make up coatings, stack plates, support plates, and gates or runners, whether integral with the mold cavity or separate from the mold cavity, are not included in the average thermal conductivity. Average thermal conductivity is calculated on a volume weighted basis.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The term “nominal wall thickness” is defined as the theoretical thickness of a mold cavity if the mold cavity were made to have a uniform thickness. The nominal wall thickness may be approximated by the average wall thickness. The nominal wall thickness may be calculated by integrating length and width of the mold cavity that is filled by an individual gate.

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates or runners, whether integral with a mold cavity or not, and support plates. Generally, average hardness refers to the volume weighted hardness of material in the mold cooling region.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the collective time it takes to perform the steps of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides.

The term “skin” or “skin layer” is defined as a surface layer of a molded part. While it is recognized that skin or skin layer can be considered in the context of a molded part's surface aesthetics, which may include the texture or finish of the part, and thus have a depth on the order of only 5% of the wall thickness, when considering the skin layer as it relates to most mechanical properties of a molded part, the skin layer may include the outer 20% of the part.

The term “flow front” refers to a leading edge of a shot of molten polymeric material, as experienced by the surfaces of the mold that define a mold cavity, as the molten polymeric material is progressing from a nozzle or gate of the mold cavity (i.e., a point or points of introduction of the molten polymeric material to the mold cavity) toward, and ultimately to, an end-of-fill location of the mold cavity.

The term “heating element” refers to any element, for example a heat pump, heat pipe, cartridge heater, electrical resistance wire, that can be used to heat, or increase the surface temperature of, one or more regions of a mold that define any part of a mold cavity. The heating element may employ a rapid heating technique to heat the regions of the mold that define any part of the mold cavity.

The term “rapid heating technique” refers to any manner of increasing the surface temperature of one or more regions of a mold that define any part of a mold cavity, in a short period of time, including resistive heating (or joule heating), conduction, convection, use of heated fluids (e.g., superheated steam or oil in a manifold or jacket, also heat exchangers), radiative heating (such as through the use of infrared radiation from filaments or other emitters), RF heating (or dielectric heating), electromagnetic inductive heating (also referred to herein as induction heating), use of thermoelectric effect (also called the Peltier-Seebeck effect), and use of heat pumps, heat pipes, cartridge heaters, or electrical resistance wires, whether or not their use is considered within the scope of any of the above-listed types of heating.

The term “cooling element” refers to any element, for example a cooling unit, that can be used to cool, or reduce the surface temperature of, one or more regions of a mold that define any part of a mold cavity using any number of various cooling techniques.

The term “cooling technique” refers to any manner of decreasing the surface temperature of one or more regions of a mold that define any part of a mold cavity, including heat exchangers, such as finned radiators or heat sinks, where a cooling fluid flowing therein (preferably a liquid medium) is at a lower temperature than the surfaces of the mold requiring cooling, thermoelectric effect heat pumps, laser cooling, leveraging endothermic phase changes, such as evaporative cooling, and use of refrigeration products with a magneto-caloric effect (wherein some materials, such as alloys of gadolinium, in the presence of a diminishing magnetic field, are chilled by the reduction of motion of magnetic dipoles in the material). In some cases, the cooling technique may be applied to decrease the surface temperature of one or more regions of a mold that define any part of a mold cavity in a short period of time, such that the cooling technique can be referred to as a rapid cooling technique.

The term “surface area of the mold” refers to the collective area of the surfaces of the mold that together form the mold walls defining one or more mold cavities, to the extent thermoplastic material injected into the mold cavity is exposed to those surfaces in order to form a full molded part.

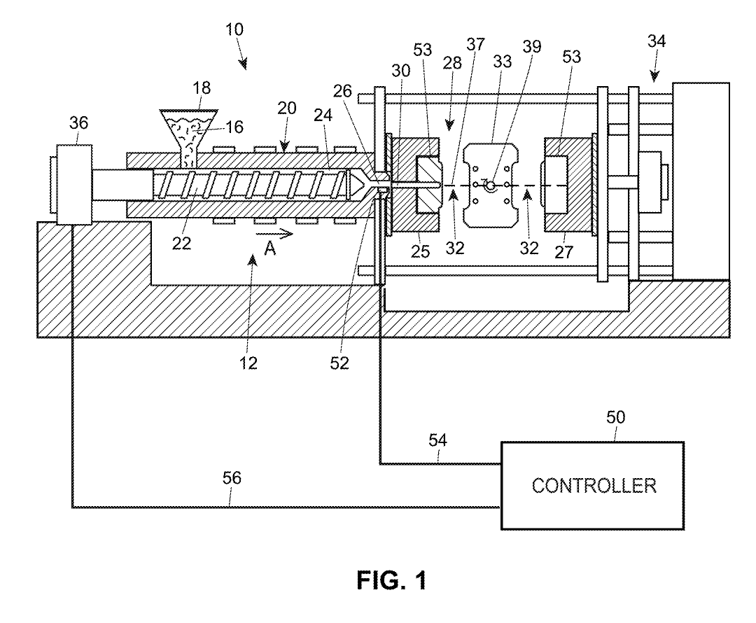

Referring to the figures in detail, FIG. 1 illustrates an exemplary injection molding apparatus 10 that generally includes an injection system 12 and a clamping system 14. A thermoplastic material may be introduced to the injection system 12 in the form of thermoplastic pellets 16. The thermoplastic pellets 16 may be placed into a hopper 18, which feeds the thermoplastic pellets 16 into a heated barrel 20 of the injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130° C. to about 410° C.

The reciprocating screw 22 forces the molten thermoplastic material 24, toward a nozzle 26 to form a shot of thermoplastic material, which will be injected into one or more mold cavities 32 of a mold 28 via one or more gates 30, preferably three or less gates. In other embodiments the nozzle 26 may be separated from one or more gates 30 by a feed system (not shown). The mold 28 illustrated in FIG. 1 includes a movable central section 33 arranged between first and second mold sides 25, 27, with each mold cavity 32 formed between the movable central section 33 and one of the first and second mold sides 25, 27 of the mold 28 (depending upon which way the mold cavity 32 is facing). In the illustrated embodiment, the shapes of each of the cavities 32 are identical, thereby creating a family of mold cavities, though this need not be the case (instead, the shapes may be similar to or different from each other). The first and/or second mold sides 25, 27 are movable toward or away from one another along a transverse axis 37, while the central section 33 is, at least in this case, rotatable about an axis 39 that is perpendicular to the transverse axis 37. When the mold 28 is closed, the movable central section 33 and the first and second mold sides 25, 27 are held together under pressure by a press or clamping unit 34. The press or clamping unit 34 applies a clamping force during the molding process that is greater than the force exerted by the injection pressure acting to separate the components of the mold 28, thereby holding the movable central section 33 and the first and second mold sides 25, 27 together while the molten thermoplastic material 24 is injected into each of the one or more mold cavities 32. To support these clamping forces, the clamping system 14 may include a mold frame and a mold base.

Once the shot of molten thermoplastic material 24 is injected into the one or more mold cavities 32, the reciprocating screw 22 stops traveling forward. The molten thermoplastic material 24 takes the form of each of the mold cavities 32 and the molten thermoplastic material 24 cools inside the mold 28 until the thermoplastic material 24 solidifies. Once the thermoplastic material 24 has solidified, the press 34 releases the first and second mold sides 25, 27, the first and second mold sides 25, 27 and the movable central section 33 are separated from one another, and the finished part may be ejected from the mold 28.

A controller 50 is communicatively connected with one or more sensors 52, located in the vicinity of the nozzle 26, and a screw control 36. The controller 50 may include a microprocessor, a memory, and one or more communication links. The sensor(s) 52 may provide an indication of when the thermoplastic material 24 is approaching the end of fill in the one or more mold cavities 32. The sensor(s) 52 may sense the presence of thermoplastic material optically, pneumatically, mechanically, electro-mechanically, or by otherwise sensing pressure and/or temperature of the thermoplastic material. When pressure or temperature of the thermoplastic material is measured by the sensor(s) 52, the sensor(s) 52 may send a signal indicative of the pressure or the temperature to the controller 50 to provide a target pressure for the controller 50 to maintain in the mold cavity(ies) 32 (or in the nozzle 26) as the fill is completed. The signal(s) may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50.

In the embodiment of FIG. 1, each sensor 52 is a pressure sensor that measures (directly or indirectly) melt pressure of the molten thermoplastic material 24 in the vicinity of the nozzle 26. Each sensor 52 generates an electrical signal that is transmitted to the controller 50. The controller 50 then commands the screw control 36 to advance the screw 22 at a rate that maintains a desired melt pressure of the molten thermoplastic material 24 in the nozzle 26. While each sensor 52 may directly measure the melt pressure, the sensor(s) 52 may also indirectly measure the melt pressure by measuring other characteristics of the molten thermoplastic material 24, such as temperature, viscosity, flow rate, etc, which are indicative of melt pressure. Likewise, the sensor(s) 52 need not be located directly in the nozzle 26, but rather the sensor(s) 52 may be located at any location within the injection system 12 or mold 28 that is fluidly connected with the nozzle 26. If the sensor(s) 52 is (are) not located within the nozzle 26, appropriate correction factors may be applied to the measured characteristic to calculate an estimate of the melt pressure in the nozzle 26. The sensor(s) 52 need not be in direct contact with the injected fluid and may alternatively be in dynamic communication with the fluid and able to sense the pressure of the fluid and/or other fluid characteristics. If the sensor(s) 52 is (are) not located within the nozzle 26, appropriate correction factors may be applied to the measured characteristic to calculate the melt pressure in the nozzle 26. In yet other embodiments, the sensor(s) 52 need not be disposed at a location that is fluidly connected with the nozzle. Rather, the sensor could measure clamping force generated by the clamping system 14 at a mold parting line between the movable central section 33 and the first and/or second mold parts 25, 27. In one aspect the controller 50 may maintain the pressure according to the input from the sensor(s) 52. Alternatively, the sensor(s) could measure an electrical power demand by an electric press, which may be used to calculate an estimate of the pressure in the nozzle.

The controller 50 may also be connected to one or more sensors 53 located in or proximate to each of the one or more mold cavities 32. For example, a plurality of sensors 53 can be arranged along various surfaces of the mold 28 that define each of the mold cavities 32. In the embodiment of FIG. 1, each sensor 53 is a temperature sensor that detects or determines the temperature of the mold 28, specifically a particular portion or region of the mold 28 that defines each of the mold cavities 32. When temperature of a portion of the mold 28 is measured by the sensor(s) 53, the sensor(s) 53 may send a signal indicative of the temperature at or near the respective mold portion to the controller 50. The signal(s) may in turn be used by the controller 50 to control the injection molding apparatus 10, e.g., by repositioning the movable central section 33, as will be described in greater detail below.

In an injection molding system, the location of the flow front of the molten polymeric material can be detected at desired locations within each of the mold cavities 32. As described above, the fact that the flow front has reached a particular location in a mold cavity 32 may be detected by a sensor 52 or 53. For instance, the sensor 52 may take the form of a pressure transducer, and may use vacuum pressure. One or more temperature sensors, such as thermal resistors, could be used instead of or in addition to a pressure sensor to determine or verify that the flow front has reached a given location of a mold cavity 32. Such a sensor 52 or 53 may operate by either sensing temperature or pressure, or by sensing a lack thereof. For instance, the sensor could sense a flow of air, and upon interruption, the sensor 52 or 53 may detect that interruption and communicate to the controller 50 that the air flow has been interrupted. Alternatively or additionally, the location of the flow front may be determined based on time, screw position (e.g., monitored using a potentiometer), hydraulic pressure, the velocity of the flow front, or some other process characteristic. As an example, the location of the flow front can be determined by monitoring the screw position, which when analyzed over time, can be used to calculate the volume of thermoplastic material in the mold 28.

The controller 50 may be connected to the sensor(s) 52, the sensor(s) 53, and the screw control 36 via wired connections 54, 56, respectively. In other embodiments, the controller 50 may be connected to the sensor(s) 52, and/or the sensor(s) 53, and screw control 56 via a wireless connection, a mechanical connection, a hydraulic connection, a pneumatic connection, or any other type of communication connection known to those having ordinary skill in the art that will allow the controller 50 to communicate with the sensor(s) 52, the sensor(s) 53, and the screw control 36.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected. It will also be appreciated that multiple controllers 50 can be employed. For example, when a plurality of sensors 52 are employed, a plurality of controllers 50 may be employed (e.g., one controller 50 corresponding to each sensor 52).

As discussed above, it is known to heat the surfaces of the mold 28 that define one or more of the mold cavities 32 after the portions 25, 27, and 33 of the mold 28 are clamped together or while the shot of molten thermoplastic material 24 is forced into each of the cavities 32; in either case, the surfaces of the mold 28 are heated while the cavities 32 are in a molded position (i.e., a position where injection molding occurs). However, as also discussed above, while doing so may enhance the appearance and strength of the injection molded part(s), it also increases cycle times (because subsequent part solidification takes longer) and increases energy consumption by the injection molding system, both in supplying additional heat to the system and in removing that heat from the walls of the mold 28.

The injection molding apparatus 10 of the present disclosure heats one or more portions (e.g., surfaces) of the mold 28 in a manner that enhances the appearance (e.g., finish) and strength of the injection molded part(s), but does so by minimizing, if not totally eliminating, the drawbacks, particularly increased cycle time and energy consumption, associated with conventional methodologies.

Specifically, the injection molding apparatus 10 locally heats, e.g., using a rapid heating technique, one or more mold cavities 32 arranged in a non-molding position, i.e., a position where injection molding does not occur. In some cases, the injection molding apparatus 10 may selectively or locally heat only discrete portions of the mold 28 that define each of the one or more mold cavities 32, such that other portions of the mold 28 remain cool (and, as a result, less cooling is required during the part solidification process). In other cases, the injection molding apparatus 10 may heat every portion of the mold 28 that defines each of the one or more mold cavities 32. In any event, when the controller 50 determines (e.g., via the sensor(s) 52 and/or sensor(s) 53) that the one or more mold cavities 32 in the non-molding position have been heated (or reheated) to a desired temperature (i.e., a temperature that is high enough to enhance the appearance and strength of the resulting injection molded part, but not high enough to significantly increase the part solidification process), the heated mold cavities 32 are moved to a molding position, whereupon the injection molding cycle begins.

The non-molding position could be offset from an initial molding position, such that the localized heating takes place subsequent to an initial injection molding operation, and subsequently, the heated mold cavities 32 are moved back to the original molding position, or alternatively, moved to a different (subsequent) molding position (e.g., a molding position oriented 180 degrees from the original molding position).”

When molten thermoplastic material 24 is subsequently injected into the heated mold cavities 32, the heated portions of the mold 28 defining the mold cavities 32 heat molten thermoplastic material 24 in contact or close proximity therewith as it flows through and fills each of the mold cavities 32. Heating the molten thermoplastic material 24 in this manner enhances the appearance and strength of injection molded parts formed in the mold cavities 32, by, for example, reducing weld lines in, and improving the surface finish of, formed injection molded parts. For example, injection molded parts produced according to the process described herein can have a smooth, matte, or high gloss finish without having to perform secondary, post cycle operations (e.g., painting).

By locally heating specific portions of the mold cavities 32, and using only the necessary amount of heat to do so, part solidification takes less time than it otherwise would (in a conventional injection molding cycle that incorporates heating), and less energy is used. Moreover, by heating the mold cavities 32 in the non-molding position, such that other steps of the injection molding process can be performed in parallel (e.g., heating and injecting can be simultaneously performed on different faces of a multi-faced (e.g., cube-shaped) indexing mold), and heating the mold cavities 32 in the targeted manner described above, the appearance and strength of injection molded parts produced by the mold 28 can be enhanced without significantly, if at all, increasing the cycle time associated with producing each injection molding part. Importantly, even if there is some increase in cycle time and/or energy consumption caused by heating the mold cavities 32 according to the present disclosure, this increased cycle time and energy consumption is still significantly less than the increase in cycle time and energy consumption that would result from incorporating conventional heating methodologies in an injection molding cycle.

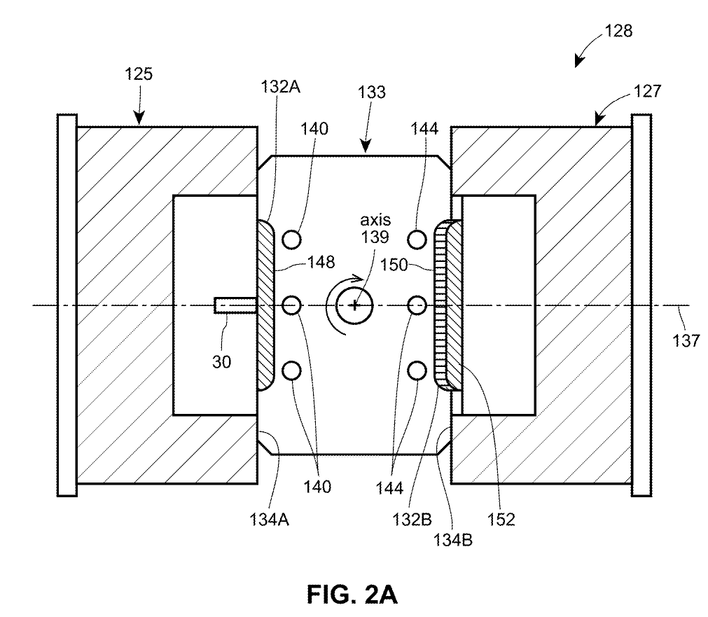

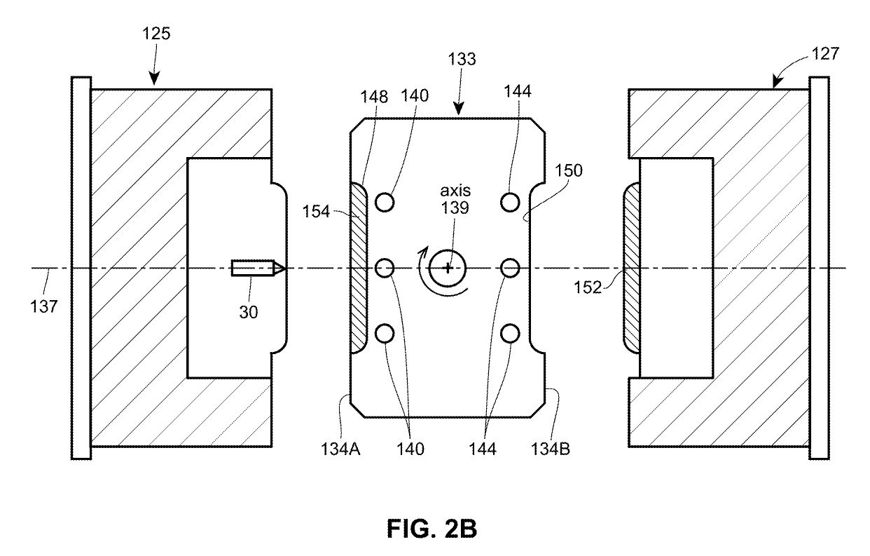

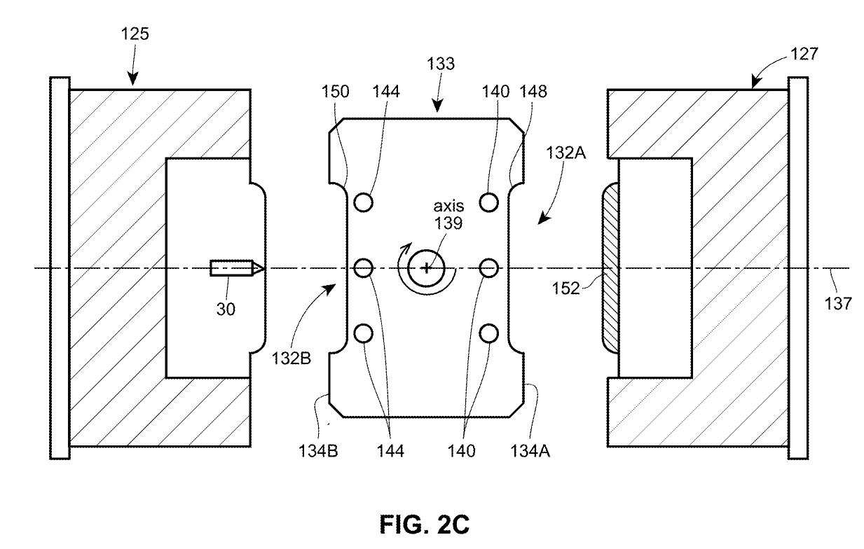

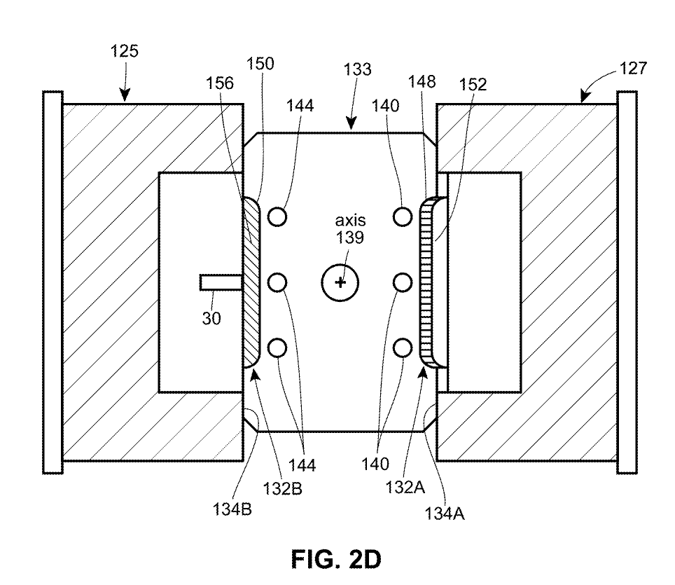

FIGS. 2A-2D illustrate one example of how heating in accordance with the present disclosure can be accomplished with a multi-faced mold 128 employed in the injection molding apparatus 10. The mold 128 in this example includes a movable central section 133 and first and second sides 125, 127. The mold 128 also includes first and second mold cavities 132A, 132B formed or defined between the movable central section 133 and a respective one of the first and second sides 125, 127 of the mold 128 (depending upon the position of the movable central section 133). More specifically, the first mold cavity 132A is formed or defined between a first face 134A of the movable central section 133 and one of the first and second sides 125, 127 of the mold 128, while the second mold cavity 132B is formed or defined between a second face 134B of the movable central section 133 and the other of the first and second sides 125, 127 of the mold 128. As illustrated in FIGS. 2A and 2B, the second face 134B is parallel to the first face 134A, with the first and second faces 134 arranged at opposite ends of the movable central section 133. The first and second sides 125, 127 are movable toward or away from one another, and the movable central section 133, along a transverse axis 137, to close or open the first and second mold cavities 132A, 132B. The movable central section 133, which in this example takes the form of a turntable, is rotatable about an axis 139 perpendicular to the transverse axis 137. The movable central section 133 is configured to rotate in a clockwise direction between two distinct positions oriented 180 degrees relative to one another, though in other examples, the movable central section 133 can rotate in a counterclockwise direction and/or between two or more different positions (e.g., positions oriented 90 degrees relative to one another).

The mold 128 also includes a plurality of first cylindrical channels 140 configured to heat or cool the first cavity 132A (depending upon the position of the central section 133) and a plurality of second cylindrical channels 144 configured to heat or cool the cavity 132B (again depending upon the position of the central section 133). Each channel of the first and second channels 140, 144 extends through the movable central section 133 in a direction parallel to the axis 139, with the first channels 140 arranged (e.g., formed, disposed) at a position proximate to the first face 134A of the movable central section 133 and evenly spaced apart from one another immediately proximate to a surface 148 of the mold 128 that partially defines the first mold cavity 132A, and the second channels 144 arranged (e.g., formed, disposed) proximate to the second face 134B and evenly spaced apart from one another along a surface 150 of the mold 128 that partially defines the second mold cavity 132B. Each channel of the first and second channels 140, 144 has a fluid, such as nitrogen, steam, heated water, flowing therethrough. When it is desired to heat the cavities 132A, 132B, the fluid flowing through the channels 140, 144 can be heated, and when it is desired to cool the cavities 132A, 132B, the fluid flowing through the channels 140, 144 can be cooled, as will be described in greater detail below.

The mold 128, at least in this example, also includes a heating element 152 that is coupled to, and extends outwardly (along the transverse axis 137) from, the second side 127. The heating element 152 in this example has a shape that is similar to an injection molding part (not shown) produced by the mold 128, such that the heating element 152 can be seated immediately proximate the surface 148 or 150, depending upon the position of the central section 133, to rapidly heat the surface 148 or 150, and thus the interior of the first cavity 132A or second cavity 132B, as will be described in greater detail below.

FIG. 2A illustrates the mold 128 in a closed position, whereby the movable central section 133 and the first and second sides 125, 127 are held together under pressure by the press or clamping unit 34, and the movable central section 133 in a first position, whereby the first cavity 132A is defined or formed between the movable central section 133 and the first side 125, and the second cavity 132B is defined or formed between the movable central section 133 and the second side 127. As illustrated in FIG. 2A, the first cavity 132A is thus positioned immediately adjacent one of the gates 30, such that the first cavity 132A is considered to be in a molding position, while the second cavity 132B, which is positioned opposite the first cavity 132A, is away, and in a different plane, from the gate 30, such that the second cavity 132A is considered to be in a non-molding position (molding cannot occur when the second cavity 132B is in this position).

Molten thermoplastic material 24 can in turn be injected into, flows through, and fill, the first mold cavity 132A. At some point, fluid, which has been cooled to a temperature less than the melt temperature of the molten thermoplastic material 24, can be introduced into, and flow through, the channels 140, helping to cool the surface 148 of the mold 128. Doing so reduces the melt temperature of the molten thermoplastic material 24 within the first mold cavity 132A, thereby helping to solidify the molten thermoplastic material 24 in the first mold cavity 132A. At the same time as molten thermoplastic material 24 is injected into, flows through, and fills, the first mold cavity 132A, a portion (e.g., the surface 150) of the second mold cavity 132B, which is positioned in the non-molding position, can be heated by: (1) the heating element 152, which extends inwardly from the second side 127 and is partially disposed in the second mold cavity 132B proximate to the surface 150, and (2) fluid, which has been heated to a temperature greater than the melt temperature of the molten thermoplastic material 24, and which has been introduced into, and flows through, the channels 144.

When the molten thermoplastic material 24 has solidified in the first mold cavity 132A (such that an injection molding part as been formed) or when the second mold cavity 132B has been heated to the desired temperature, either or both of which may be measured by, for example, one or more sensors 52, 53, the mold 128 can be moved from the closed position shown in FIG. 2A to an open position, e.g., the position shown in FIG. 2B. This is accomplished by moving the first and second sides 125, 127 away from the movable central section 133, and one another, along the transverse axis 137. In turn, an injection molding part 154 formed in the first mold cavity 132A can be ejected from the mold 128. Alternatively, the injection molding part 154 can be ejected from the mold 128 when the movable central section 133 is rotated from the first position shown in FIGS. 2A and 2B to the second position shown in FIG. 2C. Rotating the movable central section 133 from the first position shown in FIGS. 2A and 2B to the second position shown in FIG. 2C involves rotating the movable central section 133 180 degrees in a clockwise direction about the axis 139.

When the movable central section 133 has reached the second position shown in FIG. 2C, the mold 128 can again be closed by moving the first and second sides 125, 127 toward one another and into contact with the movable central section 133, along the transverse axis 137. FIG. 2D illustrates the mold 128 in the closed position, whereby the movable central section 133 and the first and second sides 125, 127 are once again held together under pressure by the press or clamping unit 34, and the movable central section 133 in the second position, whereby the first cavity 132A is now defined or formed between the movable central section 133 and the second side 127, and the second cavity 132B is now defined or formed between the movable central section 133 and the first side 125. As illustrated in FIG. 2D, the second cavity 132B is now positioned immediately adjacent one of the gates 30, such that the second cavity 132B is considered to be in a molding position, while the first cavity 132A, positioned opposite the second cavity 132B, is now away, and in a different plane, from the gate 30, such that the first cavity 132A is considered to be in a non-molding position (molding cannot occur when the first cavity 132A is in this position).

At this point, it will be appreciated that the second mold cavity 132B, which was heated to a desired temperature in the non-molding position, is now in the molding position. Thus, the heated surface 150 of the mold 128 heats the molten thermoplastic material 24, particularly the material 24 in contact or proximity therewith, as it is injected into, flows through, and fills, the second mold cavity 132B, thereby facilitating a smoother and stronger injection molded part. At some point, fluid, which has been cooled to a temperature less than the melt temperature of the molten thermoplastic material 24, is introduced into, and flows through, the channels 144, helping to cool the surface 150 of the mold 128, and thereby helping to solidify the molten thermoplastic material 24 in the second mold cavity 132B. At the same time as molten thermoplastic material 24 is injected into, flows through, and fills, the second mold cavity 132B, a portion (e.g., the surface 148) of the first mold cavity 132A, which is positioned in the non-molding position, is heated by: (1) the heating element 152, which extends inwardly from the second side 127 and is partially disposed in the first mold cavity 132B proximate to the surface 150, and (2) fluid, which has been heated to a temperature greater than the melt temperature of the molten thermoplastic material 24, and which has been introduced into, and flows through, the channels 140.

When the molten thermoplastic material 24 has solidified in the second mold cavity 132B or when the second mold cavity 132A has been heated to the desired temperature, either of both of which may be measured by one or more sensors 52, 53, the mold 128 can be moved from the closed position shown in FIG. 2D back to the open position shown in FIG. 2C by moving the first and second sides 125, 127 away from the movable central section 133, and one another, along the transverse axis 137. In turn, an injection molding part 156 formed in the second mold cavity 132B can be ejected from the mold 128. Alternatively, the injection molding part 156 can be ejected from the mold 128 when the movable central section 133 is rotated from the second position shown in FIGS. 2C and 2D back to the first position shown in FIGS. 2A and 2B. Rotating the movable central section 133 from the second position shown in FIGS. 2C and 2D to the first position shown in FIGS. 2A and 2B involves rotating the movable central section 133 180 degrees in a clockwise direction about the axis 139. It will be appreciated that in turn, the movable central section 133 has, at this point, been rotated a total of 360 degrees, i.e., it is back in its original, first position. In a similar manner as described above, the first mold cavity 132A, which was heated to a desired temperature in the non-molding position, is now back in the molding position. Thus, the heated surface 148 of the mold 128 heats the molten thermoplastic material 24 as it is injected into, flows through, and fills, the first mold cavity 132A, again facilitating a smoother and stronger injection molded part.

In other embodiments, the first and second cavities 132A, 132B can be heated or cooled in a different manner. In some cases, the mold 128 may only include one of (i) first and second channels 140, 144, and (ii) the heating element 152. In some cases, the mold 128 may include more or less channels 140, 144, so as to heat or cool more or less of the surface area of the mold 128 that defines one or more cavities. As an example, the mold 128 may include only one channel 140 and one channel 144 positioned immediately adjacent a central portion of the surfaces 148, 150, respectively, so as to only heat a central portion of the first and second mold cavities 132A, 132B. The channels 140, 144 may vary in shape and/or extend along a different direction than the channels 140, 144 shown in FIGS. 2A-2D. In some cases, the heating element 152 can have a different size and/or shape, and yet still perform the intended function of heating the surface 148 or 150, and thus the interior of the first cavity 132A or second cavity 132B. Alternatively or additionally, the first and second cavities 132A, 132B can be cooled using one or more cooling elements and/or by exposing the cavities 132A, 132B to air or other cooling medium.

In addition, the effects of heating or reheating the first and second cavities 132A, 132B can be enhanced by using one or more mold surfaces, particularly those surfaces that define part or all of the cavities 132A, 132B, having a higher thermal absorption capability than the rest of the mold 128, thereby concentrating heat in areas to be in contact or close proximity with the molten thermoplastic material 24. This can be accomplished by manufacturing one or more mold surfaces out of a material having a thermal absorption capability, by using an accelerator, catalyst, reflector, or absorber coating, or in some other manner. In some cases, a layer of insulation may be implemented between cavity inserts and the remainder of the mold 128, so as to further concentrate the heat transfer from the channels 140, 144, the heating element 152, and/or any other heating elements.

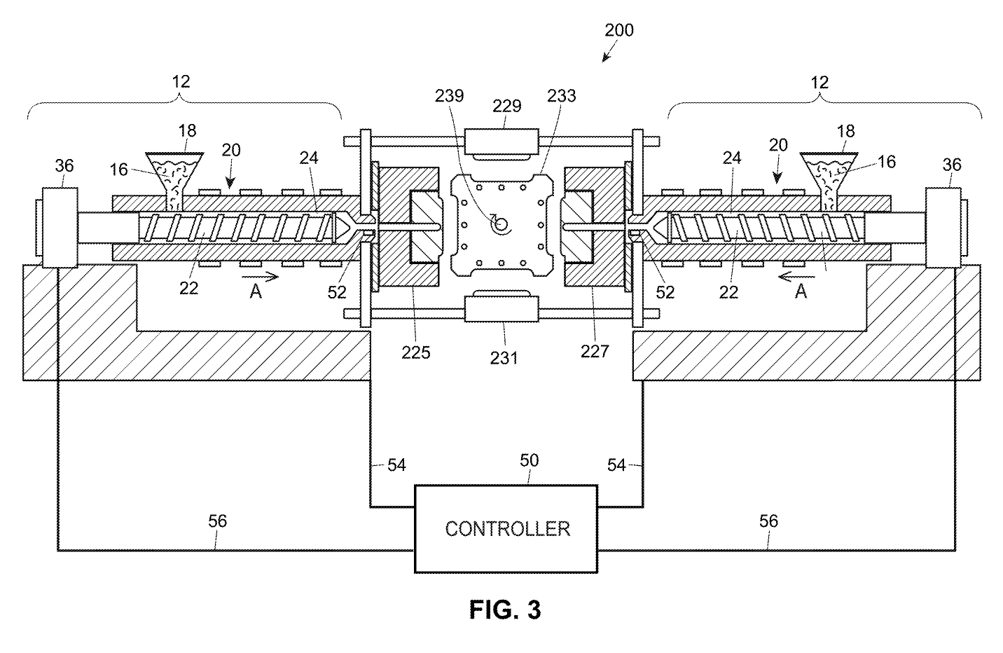

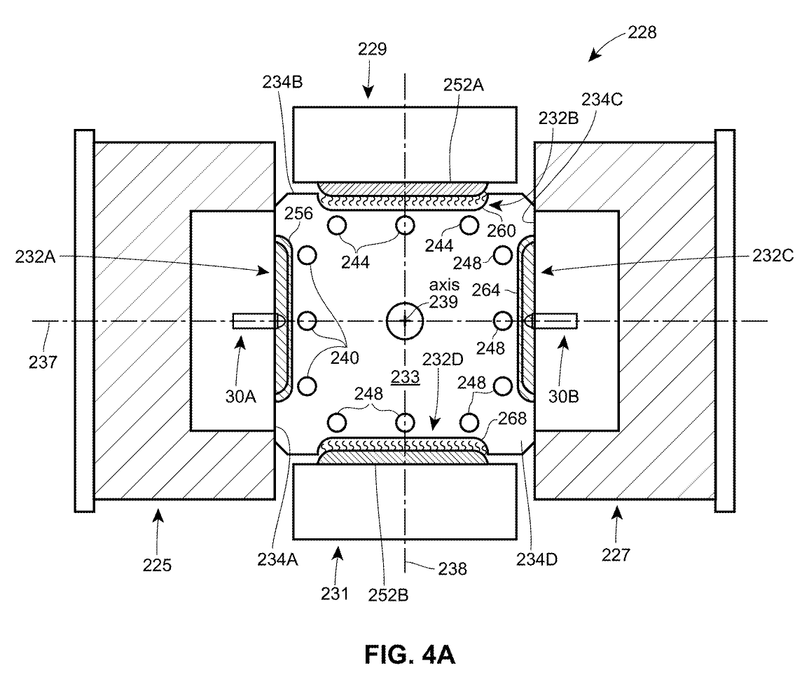

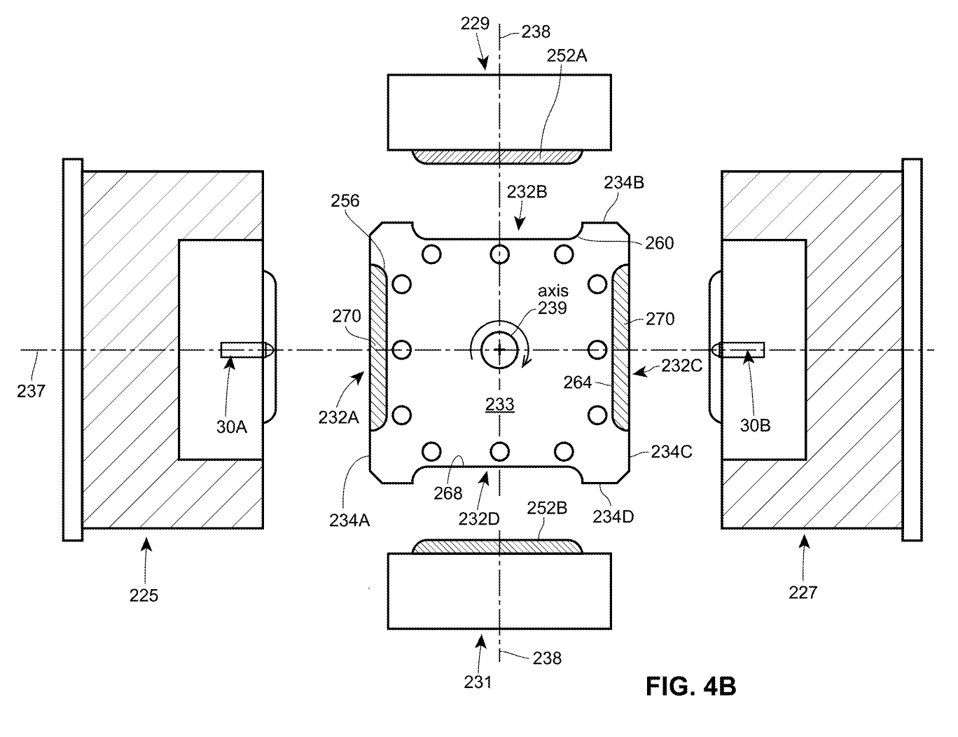

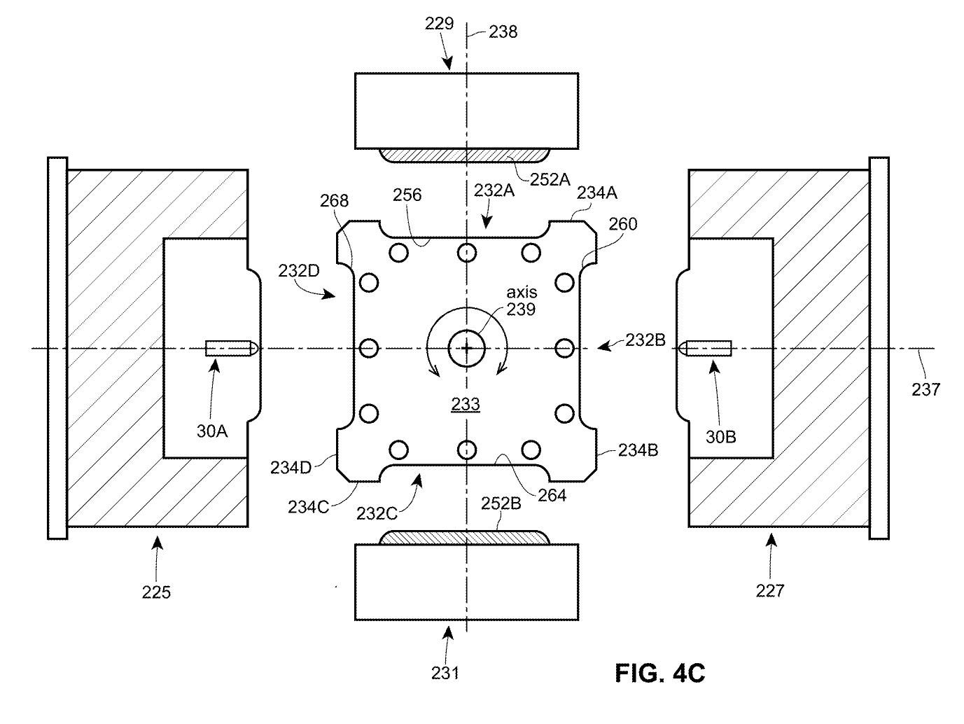

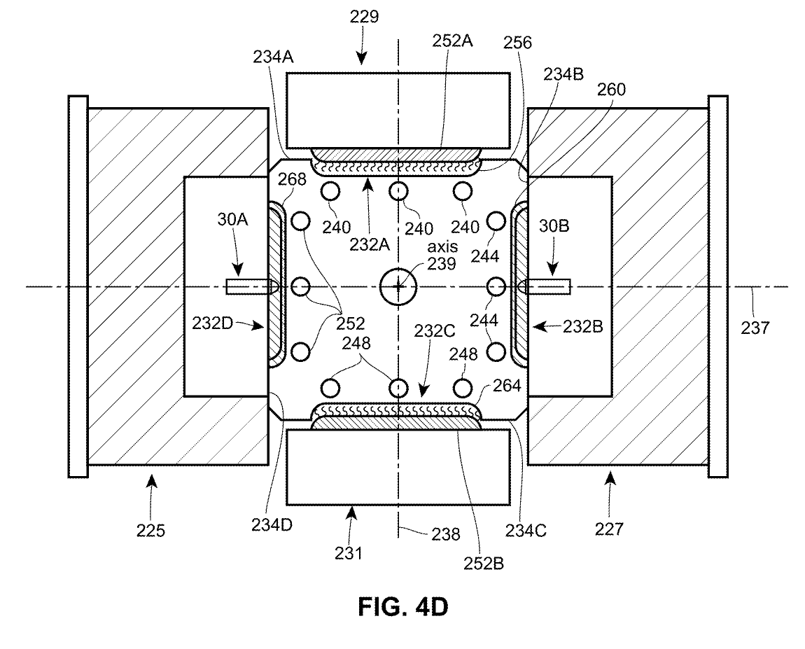

FIGS. 3 and 4A-4D illustrate another example of how heating in accordance with the present disclosure can be accomplished with a mold 228 employed in an injection molding apparatus 200.

With reference to FIG. 3, the injection molding apparatus 200 is similar to the injection molding apparatus 10 described above, with common components having common reference numerals, but includes two injection systems 12, thereby enabling the production of more injection molded parts. Like the injection molding apparatus 10, the injection molding apparatus 200 includes a controller 50 for controlling both of the injection systems 12 (though it will be appreciated that the injection molding apparatus 200 can include two different controllers 50 for controlling the different injection systems 12). In any event, the controller 50 is communicatively connected with one or more sensors 52 and a screw control 36 in a similar manner as described above. Though not illustrated in FIG. 3 (for clarity reasons), the controller 50 is also communicatively connected with one or more sensors 53 in a similar manner as described above.

As illustrated in FIGS. 4A-4D, the mold 228 in this example is a multi-faced cube mold that includes a movable central section 233, first and second sides 225, 227, and, additionally, third and fourth sides 229, 231. The mold 228 also includes four cavities 232A-232D formed or defined between the movable central section 233 and a respective one of the first thru fourth sides 225, 227, 229, 231 (depending upon the position of the movable central section 233). More specifically, the first mold cavity 232A is formed or defined between a first face 234A of the movable central section 233 and a first of the first thru fourth sides 225, 227, 229, 231 of the mold 228, the second mold cavity 232B is formed or defined between a second face 234B of the movable central section 233 and a second of the first thru fourth sides 225, 227, 229, 231 of the mold 228, the third mold cavity 232C is formed or defined between a third face 234C of the movable central section 233 and a third of the first thru fourth sides 225, 227, 229, 231 of the mold 228, and the fourth mold cavity 232D is formed or defined between a fourth face 234D of the movable central section 233 and a fourth of the first thru fourth sides 225, 227, 229, 231 of the mold 228. As illustrated in FIGS. 4A-4D, the first and third faces 234A, 234C are parallel to one another, while the second and fourth faces 234B, 234D are parallel to one another (and perpendicular to the first and third faces 234A, 234C). The first and second sides 225, 227 are movable toward or away from one another, and the movable central section 233, along a transverse axis 237, to close or open the two mold cavities positioned therebetween. The third and fourth sides 229, 231 are movable toward or away from one another, and the movable central section 233, along a longitudinal axis 238 perpendicular to the transverse axis 237. The movable central section 233, which in this example takes the form of a turntable, is rotatable about an axis 239 perpendicular to each of the transverse axis 237 and the longitudinal axis 238. The movable central section 233 is configured to rotate in a clockwise or counter-clockwise direction between fourth distinct positions oriented 90 degrees relative to one another, though in other examples, the movable central section 233 can be rotated between more or less and/or different positions (e.g., positions oriented 45 degrees relative to one another).

The mold 228 also includes a plurality of cylindrical channels 240, 244, 248, 252 configured to heat or cool a respective one of the mold cavities 232A, 232B, 232C, 232D in a similar manner as the channels 140, 144 described above. Each channel of the plurality of channels 240, 244, 248, 252 extends through the movable central section 233 in a direction parallel to the axis 239. The first channels 240 are arranged (e.g., formed, disposed) at a position proximate to the first face 234A of the movable central section 233 and evenly spaced apart from one another immediately proximate to a surface 256 of the mold 228 that partially defines the first mold cavity 232A. The second channels 244 are arranged (e.g., formed, disposed) proximate to the second face 234B and evenly spaced apart from one another along a surface 260 of the mold 228 that partially defines the second mold cavity 232B. The third channels 248 are arranged (e.g., formed, disposed) proximate to the third face 234C and evenly spaced apart from one another along a surface 264 of the mold 228 that partially defines the third mold cavity 232B. The fourth channels 252 are arranged (e.g., formed, disposed) proximate to the fourth face 234D and evenly spaced apart from one another along a surface 268 of the mold 228 that partially defines the fourth mold cavity 232D. Each channel of the channels 240, 244, 248, 252 has a fluid, such as nitrogen, steam, heated water, flowing therethrough. When it is desired to heat the cavities 232A, 232B, 232C, 232D the fluid flowing through the channels 240, 244, 248, 252, respectively, can be heated, and when it is desired to cool the cavities 232A, 232B, 232C, 232D, the fluid flowing through the channels 240, 244, 248, 252, respectively, can be cooled, as will be described in greater detail below.

The mold 228, at least in this example, also includes a pair of heating elements 252A, 252B coupled to, and extending outwardly (along the longitudinal axis 238) from, the third and fourth sides 229, 231, respectively. Like the heating element 152, each heating element 252A, 252B has a shape that is similar to an injection molding part (not shown) produced by the mold 228, such that the heating elements 252A, 252B can be seated immediately proximate two of the surfaces 256, 260, 264, 268, depending upon the position of the central section 233, to rapidly heat those two surfaces, and thus the interior of the two of the cavities 232A, 232B, 232C, 232D, as will be described in greater detail below.

FIG. 4A illustrates the mold 228 in a closed position, whereby the movable central section 233 and the sides 225, 227, 229, 231 are held together under pressure by the press or clamping unit 34, and the movable central section 233 in a first position, whereby the first cavity 232A is defined or formed between the movable central section 233 and the first side 225, the second cavity 232B is defined or formed between the movable central section 233 and the third side 229, the third cavity 232C is defined or formed between the movable central section 233 and the second side 227, and the fourth cavity 232D is defined or formed between the movable central section 233 and the fourth side 231. As illustrated in FIG. 4A, the first cavity 232A and the third cavity 232C are thus positioned opposite one another immediately adjacent opposite gates 30A, 30B, such that the first and third cavities 232A, 232C are each considered to be in a molding position, while the second and fourth cavity 232B, 232D are positioned in a different plane from the gates 30A, 30B, such that the second and fourth cavities 232B, 232D are each considered to be in a non-molding position (molding cannot occur when the second and fourth cavities 232B, 234D are in this position).

Molten thermoplastic material 24 can in turn be injected into, flow through, and fill, each of the first mold cavities 232A, 232C. At some point, fluid, which has been cooled to a temperature less than the melt temperature of the molten thermoplastic material 24, can be introduced into, and flow through, the channels 240, 248, helping to cool the surfaces 256, 264, respectively, of the mold 228. Doing so reduces the melt temperature of the molten thermoplastic material 24 within the first and third mold cavities 232A, 232C, thereby helping to solidify the molten thermoplastic material 24 in these cavities 232A, 232C. At the same time as molten thermoplastic material 24 is injected into, flows through, and fills, the first and third mold cavities 232A, 232C, a portion (e.g., the surface 260) of the second mold cavity 232B and a portion (e.g., the surface 268) of the fourth mold cavity 232D, each of which is positioned in the non-molding position, can be heated by: (1) the heating elements 252A, 252B, in a similar manner as the heating element 152, and (2) fluid, which has been heated to a temperature greater than the melt temperature of the molten thermoplastic material 24, and which has been introduced into, and flows through, the channels 240, 248.

When the molten thermoplastic material 24 has solidified in the first and third mold cavities 232A, 232C (such that an injection molding part has been formed) or when the second and fourth mold cavities 232B, 232D have been heated to the desired temperature, which may be measured by, for example, one or more sensors 52, 53, the mold 228 can be moved from the closed position shown in FIG. 4A to an open position, e.g., the position shown in FIG. 4B. This is accomplished by moving the first and second sides 225, 227 away from the movable central section 233, and one another, along the transverse axis 237, and by moving the third and fourth sides 229, 231 away from the movable central section 233, and one another, along the longitudinal axis 238. In turn, an injection molding part 270 formed in each of the first and third mold cavities 232A, 232C can be ejected from the mold 228. Alternatively, the injection molding parts 270 can be ejected from the mold 228 when the movable central section 233 is rotated from the first position shown in FIGS. 4A and 4B to a second position, e.g., the position shown in FIG. 4C. Rotating the movable central section 233 from the first position shown in FIGS. 4A and 4B to the second position shown in FIG. 4C involves rotating the movable central section 233 90 degrees in a clockwise direction about the axis 239.

When the movable central section 233 has reached the second position shown in FIG. 4C, the mold 228 can again be closed by moving the first and second sides 225, 227 toward one another and into contact with the movable central section 233, along the transverse axis 237, and by moving the third and fourth sides 229, 231 toward one another and into contact with the movable central section 233, along the longitudinal axis 238. FIG. 4D illustrates the mold 228 in the closed position, whereby the movable central section 233 and the first thru fourth sides 225, 227, 229, 231 are once again held together under pressure by the press or clamping unit 34, and the movable central section 233 in the second position. In this section position, the first cavity 232A is now defined or formed between the movable central section 233 and the third side 229, the second cavity 232B is now defined or formed between the movable central section 233 and the second side 227, the third cavity 232C is now defined or formed between the movable central section 233 and the fourth side 231, and the fourth cavity is now defined or formed between the movable central section 233 and the first side 225. As illustrated in FIG. 4D, the second and fourth cavities 232B, 232D are now positioned immediately adjacent the gates 30A, 30B, respectively, such that each of the second and fourth cavities 232B, 232D is considered to be in a molding position, while the first and third cavities 232A, 232C are positioned in a different plane from the gates 30A, 30B, such that the first and third cavities 232A, 232C are each considered to be in a non-molding position (molding cannot occur when the first and third cavities 232A, 232C are in this position).

At this point, it will be appreciated that the second and fourth mold cavities 232B, 232D, each of which was heated to a desired temperature in the non-molding position, are now in the molding position. Thus, the heated surfaces 260, 268 of the mold 228 heats the molten thermoplastic material 24, particularly the material 24 in contact or proximity therewith, as it is injected into, flows through, and fills, the second and fourth mold cavities 232B, 232D, thereby facilitating a smoother and stronger injection molded part from each cavity. At some point, fluid, which has been cooled to a temperature less than the melt temperature of the molten thermoplastic material 24, is introduced into, and flows through, the channels 244 and 252, helping to cool the surfaces 260, 268 of the mold 228, and thereby helping to solidify the molten thermoplastic material 24 in the second and fourth mold cavities 232B, 232D. At the same time as molten thermoplastic material 24 is injected into, flows through, and fills, the second and fourth mold cavities 232B, 232D, a portion (e.g., the surface 256) of the first mold cavity 232A, and a portion (e.g., the surface 264) of the third mold cavity 232C, each of which is positioned in the non-molding position, can be heated by: (1) the heating elements 252A, 252B, and (2) fluid, which has been heated to a temperature greater than the melt temperature of the molten thermoplastic material 24, and which has been introduced into, and flows through, the channels 244, 252.

When the molten thermoplastic material 24 has solidified in the second and fourth mold cavities 232B, 232D or when the first and third mold cavities 232A, 232C have been heated to the desired temperature, which may be measured by, for example, one or more sensors 52, 53, the mold 228 can be moved from the closed position shown in FIG. 4D back to the open position shown in FIG. 4C by moving the first and second sides 225, 227 away from the movable central section 233, and one another, along the transverse axis 237, and by moving the third and fourth sides 229, 231 away from the movable central section 233, and one another, along the longitudinal axis 238. In turn, an injection molding part formed in each of the second and fourth mold cavities 232B, 232D can be ejected from the mold 228. Alternatively, the injection molding parts 272 can be ejected from the mold 228 when the movable central section 233 is rotated from the second position shown in FIGS. 4C and 4D (i) back to the first position shown in FIGS. 4A and 4B by rotating the movable central section 233 90 degrees in a counter-clockwise direction about the axis 239, or (ii) to a third or fourth position, not shown, by further rotating the movable central section 233 90 or 180 degrees in a clockwise direction about the axis 239. While not illustrated and described in detail herein, it will be appreciated that in the third position, like the first position, molten thermoplastic material 24 is injected into the (now heated) first and third mold cavities 232A, 232C, and the second and fourth mold cavities 232B, 232D are simultaneously heated. Likewise, in the fourth position, molten thermoplastic material 24 is injected into the (now heated) second and fourth mold cavities 232B, 232D, while the first and third mold cavities 232A, 232C are simultaneously heated, just as in the third position. Of course, the movable central section 233 can be rotated to the third position, whereby molten thermoplastic material 24 is injected into the first and third mold cavities 232A, 232C, and the second and fourth mold cavities 232B, 232D are simultaneously heated, and then subsequently further rotated to the fourth position or rotated, in either the clockwise or counter-clockwise direction, back to another position (e.g., the first position).

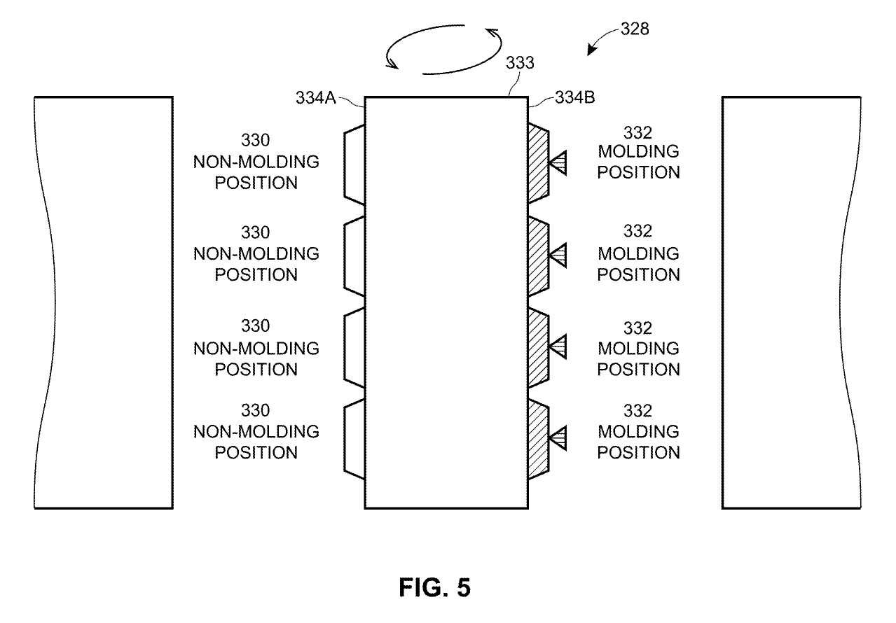

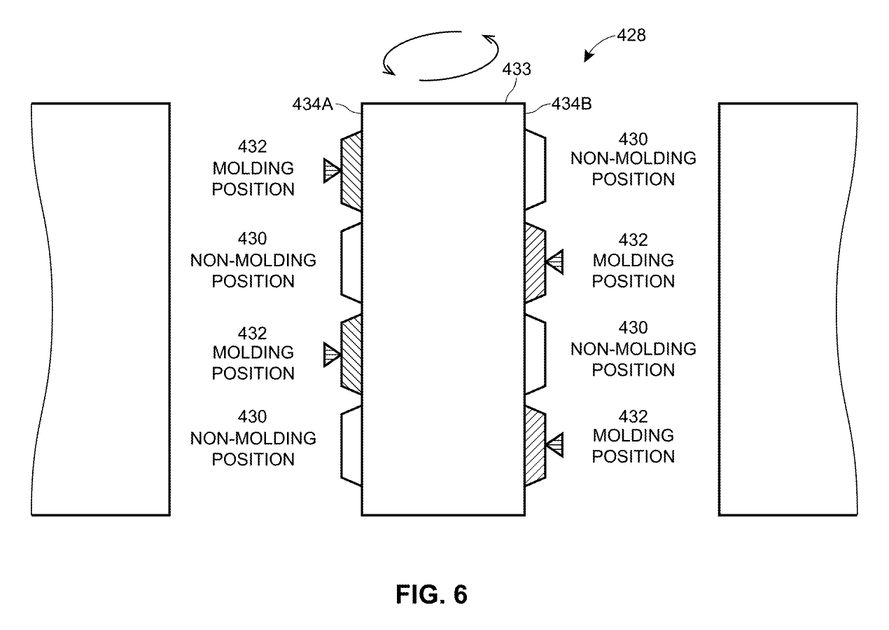

While the heating or reheating process according to the present disclosure has been described herein as being implemented using a turntable mold 128 or a cube mold 228, it will be appreciated that other molds, particularly other types of molds, e.g., helicopter, swing-arm, alternating stack, or shuttle type molds, can be used. FIG. 5, for instance, illustrates another example of a multi-faced turntable mold 328 that is similar to the turntable mold 128 but has or defines multiple non-molding positions 330 and multiple molding positions 332 oriented opposite the multiple non-molding positions 330. More specifically, the non-molding positions 330 are oriented or defined along a first face 334A of a movable central section 333 of the mold 328, while the molding positions 332 are oriented or defined along a second face 334B of the movable central section 333 of the mold 328 opposite the first face 334A. FIG. 6 illustrates another example of a multi-faced turntable mold 428 that is similar to the multi-faced mold turntable mold 328, but has or defines alternating non-molding positions 430 and molding positions 432. More specifically, two non-molding positions 430 and two molding positions 432 are oriented or defined, and alternate, along a first face 434A of a movable central section 433 of the mold 428, while two non-molding positions 430 and two molding positions 432 are oriented or defined, and alternate, along a second face 434B of the movable central section 433 of the mold 428 opposite the first face 434A.

Moreover, while the process according to the present disclosure has been described herein as being implemented across different mold cavities of the same mold, it will be appreciated that the process can be implemented across multiple molds of the same or different injection molding apparatus(es), regardless of whether those molds are being used to make the same or different parts.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of injection molding, comprising:
injecting a molten thermoplastic material into a mold cavity defined by a mold of an injection molding system, the injecting being performed when the mold cavity is in a first molding position;
forming a molded article by reducing a mold temperature of the molten thermoplastic material within the mold cavity;
ejecting the molded article from the mold cavity;
moving the mold cavity from the first molding position to a non-molding position;
heating at least a portion of a wall of the mold cavity when the mold cavity is in the non-molding position;
moving the mold cavity from the non-molding position to one of the first molding position or a second molding position different from the first molding position; and
when the mold is in the first or second molding position, injecting the molten thermoplastic material into the mold cavity having the at least partially heated wall.

2. The method of claim 1, wherein the forming and the ejecting are performed when the mold cavity is in the first molding position.

3. The method of claim 1, further comprising, prior to the injecting, closing the mold by moving first and second mold portions toward one another in a transverse direction, and prior to the ejecting, opening the mold by moving the first and second mold portions away from one another in the transverse direction, wherein moving the mold cavity from the first molding position to the non-molding position comprises rotating the mold cavity about an axis extending perpendicular to the transverse direction.

4. The method of claim 1, wherein the mold comprises one of a group consisting of a cube mold, a helicopter mold, a swing-arm mold, and an alternating stack.

5. The method of claim 1, wherein the mold comprises a turntable, and wherein movement of the turntable moves the mold cavity from the first molding position to the non-molding position.

6. The method of claim 1, wherein moving the mold cavity from the first molding position to the non-molding position comprises rotating the mold cavity.

7. The method of claim 6, wherein rotating the mold cavity comprises rotating the mold cavity by 90 degrees in a clockwise or counter-clockwise direction.

8. The method of claim 1, wherein moving the mold cavity from the non-molding position to the first or second molding position comprises rotating the mold cavity by 90 degrees in a clockwise or counter-clockwise direction.

9. The method of claim 1, wherein the molded article is ejected from the molded cavity when the mold cavity is moved from the first molding position to the non-molding position.

10. The method of claim 1, wherein the non-molding position is outside of a plane of the first molding position.

11. The method of claim 1, wherein the formed molded article has a glossy finish without performing secondary operations to improve the finish.

12. The method of claim 1, wherein heating at least the portion of the mold cavity comprises heating at least the portion of the mold cavity using at least one of a group consisting of induction heating, microwave heating, infrared radiation, acoustic heating, convection, and conduction.

13. The method of claim 12, wherein heating at least the portion of the mold cavity comprises heating a fluid flowing through one or more channels formed in the mold cavity when the mold cavity is in the non-molding position.

14. The method of claim 13, further comprising cooling the fluid when the mold cavity is in the first or second molding position, wherein the cooled fluid is used to reduce the mold temperature of the thermoplastic material within the mold cavity.

15. The method of claim 13 or 14, wherein the fluid comprises nitrogen.

16. The method of claim 1, wherein heating at least the portion of the mold cavity comprises locally heating only the portion of the mold cavity.

17. A method of injection molding, comprising:
injecting a molten thermoplastic material into a first mold cavity defined by a mold of an injection molding system;
forming a first molded article by reducing a mold temperature of the molten thermoplastic material within the first mold cavity;
ejecting the molded article from the first mold cavity;
heating at least a portion of a wall of the first mold cavity; and
performing, during the heating, one or more acts from a group of injection molding acts consisting of:
injecting the molten thermoplastic material into a second mold cavity defined by the mold of the injection molding system;
forming a second molded article by reducing a mold temperature of the thermoplastic material within the second mold cavity; and
ejecting the second molded article from the second mold cavity.

18. The method of claim 17, wherein injecting the molten thermoplastic material into the first mold cavity is performed when the first mold cavity is in a molded position, the method further comprising moving the first mold cavity from the molded position to a non-molded position, wherein heating at least the portion of the first mold cavity is performed when the first mold cavity is in the non-molded position.

19. The method of claim 18, wherein when the first mold cavity is moved from the molded position to the non-molded position, the second mold cavity is moved to a molded position.

20. A method of injection molding, comprising:
heating at least a portion of a wall of a mold cavity defined by a mold of an injection molding system when the mold cavity is in a non-molding position;
moving the mold cavity from the non-molding position to a molding position;
injecting a molten thermoplastic material into the mold cavity having the at least partially heated wall, the injecting being performed when the mold cavity is in the molding position;
forming a molded article by reducing a mold temperature of the molten thermoplastic material within the mold cavity; and
ejecting the molded article from the mold cavity.
